(19) United States
(12) Patent Application Publication
(10) Pub. No.: US 2025/0008594 A1
(43) Pub. Date: Jan. 2, 2025

(54) COMPUTERIZED SYSTEMS AND METHODS FOR AN ADAPTIVE MULTI-LINK OPERATION MESH NETWORK

(71) Applicant: PLUME DESIGN, INC., Palo Alto, CA (US)

(72) Inventor: Badri Srinivasan SAMPATHKUMAR, Fremont, CA (US)

(21) Appl. No.: 18/343,224

(22) Filed: Jun. 28, 2023

(51) Int. Cl. H04W 76/27

(52) U.S. Cl. CPC H04W 76/27; H04W 84/18

(57) ABSTRACT

Disclosed are systems and methods that provide a computerized network management framework that adaptively configures a network at a location to optimize network usage and application operation thereon. The disclosed framework enables the implementation of MLO functionality within WiFi 7 enabled mesh networks based on end user activity. The disclosed network management framework can leverage information related to the detection of application instances on a network, in addition to determinations of such applications' priority of operations on the network, and dynamically activate MLO links across certain branches of the topology of a location's network (e.g., the locations' operational mesh network). This, among other benefits, can provide faster speeds, lower latency and increased capacity for the network and the devices operating therein/thereon.

### FIELD OF THE DISCLOSURE

The present disclosure is generally related to management of a network, and more particularly, to a decision intelligence (DI)-based computerized framework for deterministically managing, controlling and/or configuring multi-link operation (MLO) functionality of a mesh network at a location.

### BACKGROUND

WiFi 7, also referred to as IEEE 802.11be, is the latest generation of wireless technology.

### SUMMARY OF THE DISCLOSURE

WiFi 7 is designed to provide faster speeds, lower latency and increased capacity compared to previous WiFi standards. Among other benefits, WiFi 7 can provide extreme high throughput (EHT), and can support multi-access point (AP) coordination (e.g., coordination and joint transmission.

WiFi 7 includes functionality to bond WiFi links across multiple radios/frequency bands together into a single multi-link device, which provides the ability to transmit packets destined for that endpoint via either of the constituent links. This ability translates to improved throughput performance and capacity since such metrics can now become additive amongst the constituent links. For example, WiFi 7 provides improved latency in traffic flows due to the ability to send traffic over the less congested link.

As discussed herein, according to some embodiments, disclosed are systems and methods for utilizing MLO functionality within WiFi 7 enabled mesh networks based on end user activity. As discussed below, according to some embodiments, the disclosed network management framework can leverage information related to the detection of application instances on a network, in addition to determinations of such applications' priority of operations on the network, and dynamically activate MLO links across certain branches of the topology of a location's network (e.g., the locations' operational mesh network, as discussed below). This, among other benefits, can provide faster speeds, lower latency and increased capacity for the network and the devices operating therein/thereon.

Thus, according to some embodiments, the disclosed systems and methods provide a novel computerized network management framework that adaptively configures network usage and/or network parameters/characteristics at a location based on determined intelligence about the network, devices executing therein/there-around and behavioral patterns of users in/around the location. According to some embodiments, as discussed herein, the disclosed framework can leverage information related to network capacity and coverage against network activity (e.g., upload/download, streaming, and the like) of devices connected to the network to determine) which applications are to be prioritized, and/or which devices operating such applications should be prioritized. Accordingly, this information can be utilized to dynamically and adaptively activate MLO links for such devices, which can enable an improved network and user experience. Accordingly, as discussed herein, network configurations and/or network parameters can be managed, modified and manipulated to dynamically determined and evolving runtime environments so as to ensure the operational integrity of the applications/devices connected to and operating on the network.

It should be understood that while the discussion herein will focus on WiFi 7 and mesh networks at a location, it should not be construed as limiting, as any type of known or to be known type of network for which MLO functionality can be implemented can be utilized via the disclosed systems and methods without departing from the scope of the instant disclosure.

According to some embodiments, a method is disclosed for adaptively activating MLO functionality for a network based on application detection and prioritization. In accordance with some embodiments, the present disclosure provides a non-transitory computer-readable storage medium for carrying out the above-mentioned technical steps of the framework's functionality. The non-transitory computer-readable storage medium has tangibly stored thereon, or tangibly encoded thereon, computer readable instructions that when executed by a device cause at least one processor to perform a method for adaptively activating MLO functionality for a network based on application detection and prioritization.

In accordance with one or more embodiments, a system is provided that includes one or more processors and/or computing devices configured to provide functionality in accordance with such embodiments. In accordance with one or more embodiments, functionality is embodied in steps of a method performed by at least one computing device. In accordance with one or more embodiments, program code (or program logic) executed by a processor(s) of a computing device to implement functionality in accordance with one or more such embodiments is embodied in, by and/or on a non-transitory computer-readable medium.

### DESCRIPTIONS OF THE DRAWINGS

The features, and advantages of the disclosure will be apparent from the following description of embodiments as illustrated in the accompanying drawings, in which reference characters refer to the same parts throughout the various views. The drawings are not necessarily to scale, emphasis instead being placed upon illustrating principles of the disclosure:

FIG. 1 is a block diagram of an example configuration within which the systems and methods disclosed herein could be implemented according to some embodiments of the present disclosure;

FIG. 2 is a block diagram illustrating components of an exemplary system according to some embodiments of the present disclosure;

FIG. 3 illustrates an exemplary workflow according to some embodiments of the present disclosure;

FIG. 4 illustrates an exemplary workflow according to some embodiments of the present disclosure;

FIG. 5 depicts a non-limiting example network environment according to some embodiments of the present disclosure;

FIG. 6 depicts an exemplary implementation of an architecture according to some embodiments of the present disclosure;

FIG. 7 depicts an exemplary implementation of an architecture according to some embodiments of the present disclosure; and

FIG. 8 is a block diagram illustrating a computing device showing an example of a client or server device used in various embodiments of the present disclosure.

### DETAILED DESCRIPTION

The present disclosure will now be described more fully hereinafter with reference to the accompanying drawings, which form a part hereof, and which show, by way of non-limiting illustration, certain example embodiments. Subject matter may, however, be embodied in a variety of different forms and, therefore, covered or claimed subject matter is intended to be construed as not being limited to any example embodiments set forth herein; example embodiments are provided merely to be illustrative. Likewise, a reasonably broad scope for claimed or covered subject matter is intended. Among other things, for example, subject matter may be embodied as methods, devices, components, or systems. Accordingly, embodiments may, for example, take the form of hardware, software, firmware or any combination thereof (other than software per se). The following detailed description is, therefore, not intended to be taken in a limiting sense.

Throughout the specification and claims, terms may have nuanced meanings suggested or implied in context beyond an explicitly stated meaning. Likewise, the phrase “in one embodiment” as used herein does not necessarily refer to the same embodiment and the phrase “in another embodiment” as used herein does not necessarily refer to a different embodiment. It is intended, for example, that claimed subject matter include combinations of example embodiments in whole or in part.

In general, terminology may be understood at least in part from usage in context. For example, terms, such as “and”, “or”, or “and/or,” as used herein may include a variety of meanings that may depend at least in part upon the context in which such terms are used. Typically, “or” if used to associate a list, such as A, B or C, is intended to mean A, B, and C, here used in the inclusive sense, as well as A, B or C, here used in the exclusive sense. In addition, the term “one or more” as used herein, depending at least in part upon context, may be used to describe any feature, structure, or characteristic in a singular sense or may be used to describe combinations of features, structures or characteristics in a plural sense. Similarly, terms, such as “a,” “an,” or “the,” again, may be understood to convey a singular usage or to convey a plural usage, depending at least in part upon context. In addition, the term “based on” may be understood as not necessarily intended to convey an exclusive set of factors and may, instead, allow for existence of additional factors not necessarily expressly described, again, depending at least in part on context.

The present disclosure is described below with reference to block diagrams and operational illustrations of methods and devices. It is understood that each block of the block diagrams or operational illustrations, and combinations of blocks in the block diagrams or operational illustrations, can be implemented by means of analog or digital hardware and computer program instructions. These computer program instructions can be provided to a processor of a general purpose computer to alter its function as detailed herein, a special purpose computer, ASIC, or other programmable data processing apparatus, such that the instructions, which execute via the processor of the computer or other programmable data processing apparatus, implement the functions/acts specified in the block diagrams or operational block or blocks. In some alternate implementations, the functions/acts noted in the blocks can occur out of the order noted in the operational illustrations. For example, two blocks shown in succession can in fact be executed substantially concurrently or the blocks can sometimes be executed in the reverse order, depending upon the functionality/acts involved.

For the purposes of this disclosure a non-transitory computer readable medium (or computer-readable storage medium/media) stores computer data, which data can include computer program code (or computer-executable instructions) that is executable by a computer, in machine readable form. By way of example, and not limitation, a computer readable medium may include computer readable storage media, for tangible or fixed storage of data, or communication media for transient interpretation of code-containing signals. Computer readable storage media, as used herein, refers to physical or tangible storage (as opposed to signals) and includes without limitation volatile and non-volatile, removable and non-removable media implemented in any method or technology for the tangible storage of information such as computer-readable instructions, data structures, program modules or other data. Computer readable storage media includes, but is not limited to, RAM, ROM, EPROM, EEPROM, flash memory or other solid state memory technology, optical storage, cloud storage, magnetic storage devices, or any other physical or material medium which can be used to tangibly store the desired information or data or instructions and which can be accessed by a computer or processor.

For the purposes of this disclosure the term “server” should be understood to refer to a service point which provides processing, database, and communication facilities. By way of example, and not limitation, the term “server” can refer to a single, physical processor with associated communications and data storage and database facilities, or it can refer to a networked or clustered complex of processors and associated network and storage devices, as well as operating software and one or more database systems and application software that support the services provided by the server. Cloud servers are examples.

For the purposes of this disclosure a “network” should be understood to refer to a network that may couple devices so that communications may be exchanged, such as between a server and a client device or other types of devices, including between wireless devices coupled via a wireless network, for example. A network may also include mass storage, such as network attached storage (NAS), a storage area network (SAN), a content delivery network (CDN) or other forms of computer or machine-readable media, for example. A network may include the Internet, one or more local area networks (LANs), one or more wide area networks (WANs), wire-line type connections, wireless type connections, cellular or any combination thereof. Likewise, sub-networks, which may employ different architectures or may be compliant or compatible with different protocols, may interoperate within a larger network.

For purposes of this disclosure, a “wireless network” should be understood to couple client devices with a network. A wireless network may employ stand-alone ad-hoc networks, mesh networks, Wireless LAN (WLAN) networks, cellular networks, or the like. A wireless network may further employ a plurality of network access technologies, including Wi-Fi, Long Term Evolution (LTE), WLAN, Wireless Router mesh, or 2nd, 3rd, 4^{th} or 5^{th} generation (2G, 3G, 4G or 5G) cellular technology, mobile edge computing (MEC), Bluetooth, 802.11b/g/n, or the like. Network access technologies may enable wide area coverage for devices, such as client devices with varying degrees of mobility, for example.

In short, a wireless network may include virtually any type of wireless communication mechanism by which signals may be communicated between devices, such as a client device or a computing device, between or within a network, or the like.

A computing device may be capable of sending or receiving signals, such as via a wired or wireless network, or may be capable of processing or storing signals, such as in memory as physical memory states, and may, therefore, operate as a server. Thus, devices capable of operating as a server may include, as examples, dedicated rack-mounted servers, desktop computers, laptop computers, set top boxes, integrated devices combining various features, such as two or more features of the foregoing devices, or the like.

For purposes of this disclosure, a client (or user, entity, subscriber or customer) device may include a computing device capable of sending or receiving signals, such as via a wired or a wireless network. A client device may, for example, include a desktop computer or a portable device, such as a cellular telephone, a smart phone, a display pager, a radio frequency (RF) device, an infrared (IR) device a Near Field Communication (NFC) device, a Personal Digital Assistant (PDA), a handheld computer, a tablet computer, a phablet, a laptop computer, a set top box, a wearable computer, smart watch, an integrated or distributed device combining various features, such as features of the forgoing devices, or the like.

A client device may vary in terms of capabilities or features. Claimed subject matter is intended to cover a wide range of potential variations, such as a web-enabled client device or previously mentioned devices may include a high-resolution screen (HD or 4K for example), one or more physical or virtual keyboards, mass storage, one or more accelerometers, one or more gyroscopes, global positioning system (GPS) or other location-identifying type capability, or a display with a high degree of functionality, such as a touch-sensitive color 2D or 3D display, for example.

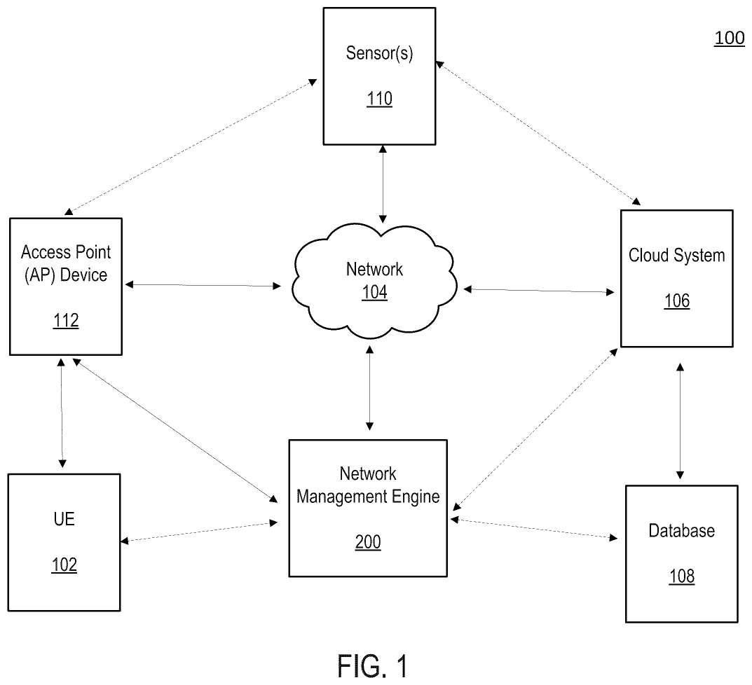

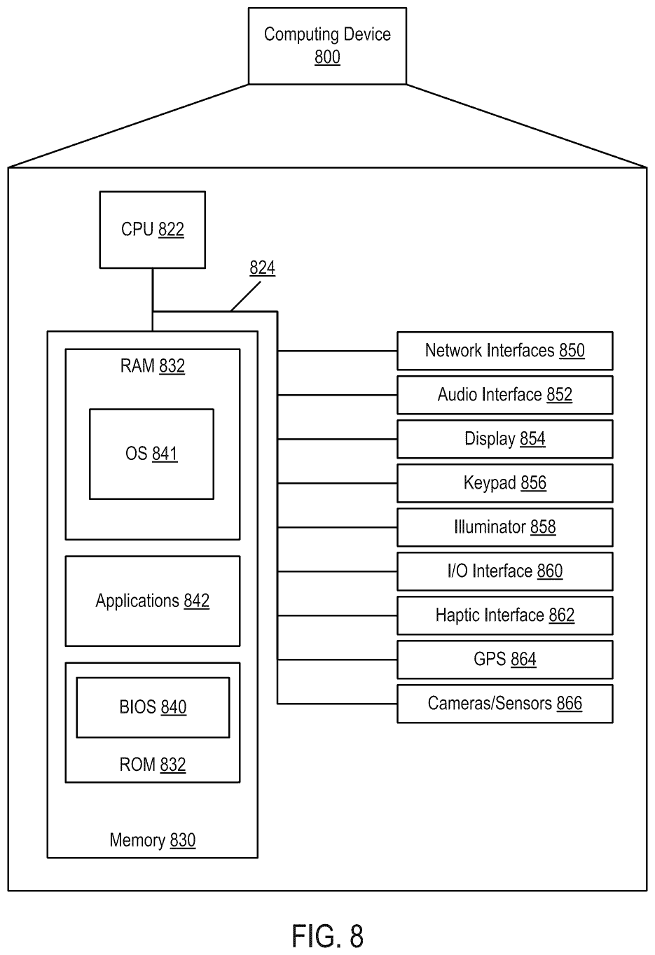

Certain embodiments and principles will be discussed in more detail with reference to the figures. With reference to FIG. 1, system 100 is depicted which includes user equipment (UE) 102 (e.g., a client device, as mentioned above and discussed below in relation to FIG. 8), access point (AP) device 112, network 104, cloud system 106, database 108, sensors 110 and network management engine 200. It should be understood that while system 100 is depicted as including such components, it should not be construed as limiting, as one of ordinary skill in the art would readily understand that varying numbers of UEs, AP devices, peripheral devices, sensors, cloud systems, databases and networks can be utilized; however, for purposes of explanation, system 100 is discussed in relation to the example depiction in FIG. 1.

According to some embodiments, UE 102 can be any type of device, such as, but not limited to, a mobile phone, tablet, laptop, sensor, IoT device, wearable device, autonomous machine, and any other device equipped with a cellular or wireless or wired transceiver.

In some embodiments, peripheral devices (not shown) can be connected to UE 102, and can be any type of peripheral device, such as, but not limited to, a wearable device (e.g., smart watch), printer, speaker, sensor, and the like. In some embodiments, a peripheral device can be any type of device that is connectable to UE 102 via any type of known or to be known pairing mechanism, including, but not limited to, WiFi, Bluetooth™, Bluetooth Low Energy (BLE), NFC, and the like.

According to some embodiments, AP device 112 is a device that creates and/or provides a wireless local area network (WLAN) for the location. According to some embodiments, the AP device 112 can be, but is not limited to, a router, switch, hub, gateway, extender and/or any other type of network hardware that can project a WiFi signal to a designated area. In some embodiments, UE 102 may be an AP device.

According to some embodiments, sensors 110 can correspond to any type of device, component and/or sensor associated with a location of system 100 (referred to, collectively, as “sensors”). In some embodiments, the sensors 110 can be any type of device that is capable of sensing and capturing data/metadata related to activity of the location. For example, the sensors 110 can include, but not be limited to, cameras, motion detectors, door and window contacts, heat and smoke detectors, passive infrared (PIR) sensors, time-of-flight (ToF) sensors, and the like. In some embodiments, the sensors can be associated with devices associated with the location of system 100, such as, for example, lights, smart locks, garage doors, smart appliances (e.g., thermostat, refrigerator, television, personal assistants (e.g., Alexa®, Nest®, for example)), smart phones, smart watches or other wearables, tablets, personal computers, and the like, and some combination thereof. For example, the sensors 110 can include the sensors on UE 102 (e.g., smart phone) and/or peripheral device (e.g., a paired smart watch). In some embodiments, sensors 110 can be associated with any device connected and/or operating on cloud system 106 (e.g., a cloud-based device, such as a server that collects information related to the location, for example).

In some embodiments, network 104 can be any type of network, such as, but not limited to, a wireless network, cellular network, the Internet, and the like (as discussed above). Network 104 facilitates connectivity of the components of system 100, as illustrated in FIG. 1.

According to some embodiments, cloud system 106 may be any type of cloud operating platform and/or network based system upon which applications, operations, and/or other forms of network resources may be located. For example, system 106 may be a service provider and/or network provider from where services and/or applications may be accessed, sourced or executed from. For example, system 106 can represent the cloud-based architecture associated with a smart home or network provider, which has associated network resources hosted on the internet or private network (e.g., network 104), which enables (via engine 200) the energy management discussed herein.

In some embodiments, cloud system 106 may include a server(s) and/or a database of information which is accessible over network 104. In some embodiments, a database 108 of cloud system 106 may store a dataset of data and metadata associated with local and/or network information related to a user(s) of the components of system 100 and/or each of the components of system 100 (e.g., UE 102, AP device 112, sensors 110, and the services and applications provided by cloud system 106 and/or network management engine 200).

In some embodiments, for example, cloud system 106 can provide a private/proprietary management platform, whereby engine 200, discussed infra, corresponds to the novel functionality system 106 enables, hosts and provides to a network 104 and other devices/platforms operating thereon.

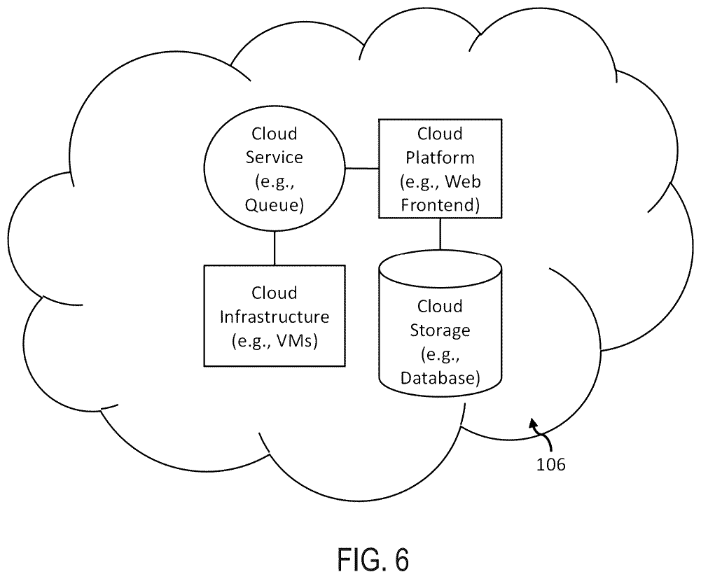

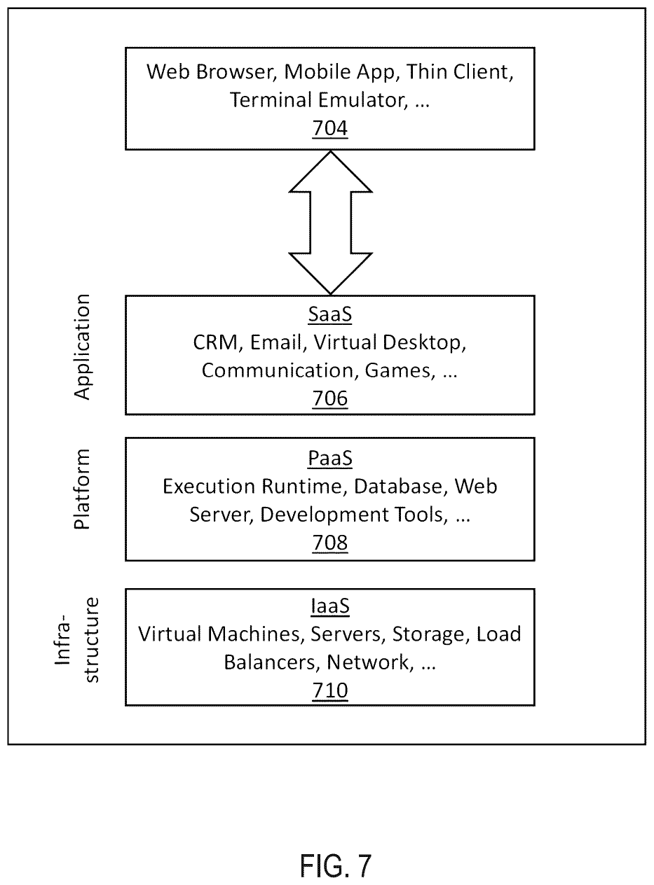

Turning to FIGS. 6 and 7, in some embodiments, the exemplary computer-based systems/platforms, the exemplary computer-based devices, and/or the exemplary computer-based components of the present disclosure may be specifically configured to operate in a cloud computing/architecture 106 such as, but not limiting to: infrastructure as a service (IaaS) 710, platform as a service (PaaS) 708, and/or software as a service (SaaS) 706 using a web browser, mobile app, thin client, terminal emulator or other endpoint 704. FIGS. 6 and 7 illustrate schematics of non-limiting implementations of the cloud computing/architecture(s) in which the exemplary computer-based systems for administrative customizations and control of network-hosted application program interfaces (APIs) of the present disclosure may be specifically configured to operate.

Turning back to FIG. 1, according to some embodiments, database 108 may correspond to a data storage for a platform (e.g., a network hosted platform, such as cloud system 106, as discussed supra) or a plurality of platforms. Database 108 may receive storage instructions/requests from, for example, engine 200 (and associated microservices), which may be in any type of known or to be known format, such as, for example, standard query language (SQL). According to some embodiments, database 108 may correspond to any type of known or to be known storage, for example, a memory or memory stack of a device, a distributed ledger of a distributed network (e.g., blockchain, for example), a look-up table (LUT), and/or any other type of secure data repository.

Network management engine 200, as discussed above and further below in more detail, can include components for the disclosed functionality. According to some embodiments, network management engine 200 may be a special purpose machine or processor, and can be hosted by a device on network 104, within cloud system 106, on AP device 112 and/or on UE 102. In some embodiments, engine 200 may be hosted by a server and/or set of servers associated with cloud system 106.

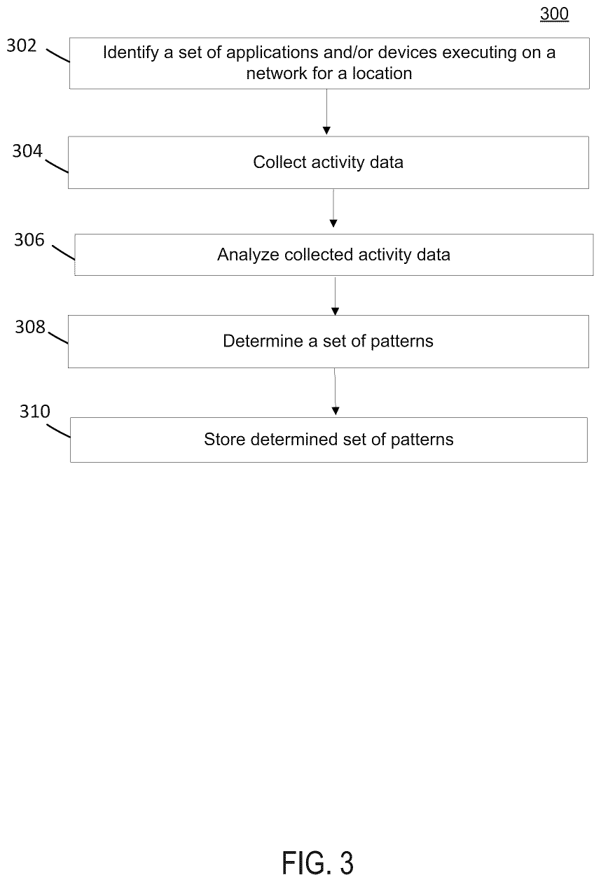

According to some embodiments, as discussed in more detail below, network management engine 200 may be configured to implement and/or control a plurality of services and/or microservices, where each of the plurality of services/microservices are configured to execute a plurality of workflows associated with performing the disclosed network management. Non-limiting embodiments of such workflows are provided below in relation to at least FIGS. 3-5.

According to some embodiments, as discussed above, network management engine 200 may function as an application provided by cloud system 106. In some embodiments, engine 200 may function as an application installed on a server(s), network location and/or other type of network resource associated with system 106. In some embodiments, engine 200 may function as an application installed and/or executing on AP device 112, UE 102 and/or sensors 110. In some embodiments, such application may be a web-based application accessed by AP device 112, UE 102 and/or devices associated with sensors 110 over network 104 from cloud system 106. In some embodiments, engine 200 may be configured and/or installed as an augmenting script, program or application (e.g., a plug-in or extension) to another application or program provided by cloud system 106 and/or executing on AP device 112, UE 102 and/or sensors 110.

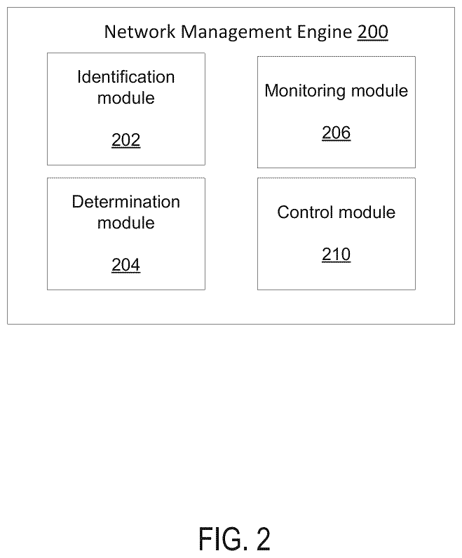

As illustrated in FIG. 2, according to some embodiments, network management engine 200 includes collection module 202, determination module 204, monitoring module 206 and control module 208. It should be understood that the engine(s) and modules discussed herein are non-exhaustive, as additional or fewer engines and/or modules (or sub-modules) may be applicable to the embodiments of the systems and methods discussed. More detail of the operations, configurations and functionalities of engine 200 and each of its modules, and their role within embodiments of the present disclosure will be discussed below.

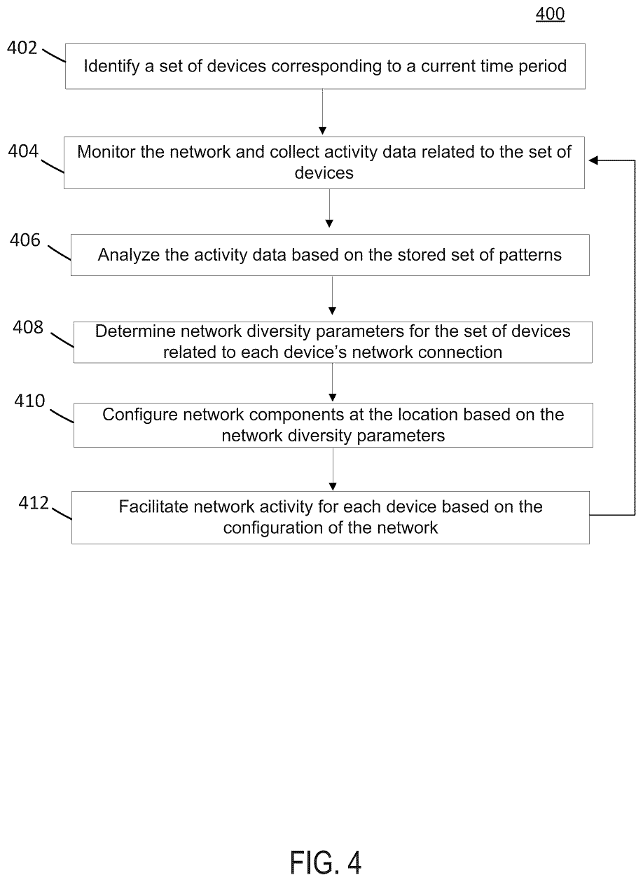

Turning to FIG. 3, Process 300 provides non-limiting example embodiments for the disclosed network management framework. According to some embodiments, Process 300 provides the executable steps for collecting data about the network's operational environment, which as discussed below in relation to Process 400 of FIG. 4, enables the adaptive management of the network and its associated application/device management/control.

According to some embodiments, Steps 302-304 of Process 300 can be performed by identification module 202 of network management engine 200; and Steps 306-310 can be performed by determination module 204.

According to some embodiments, Process 300 begins with Step 302 where engine 200 can identify a set of applications and/or devices associated with a location. In some embodiments, the set of devices can be devices that are connected to a network associated with the location, and/or connect to the network at least a threshold amount of times per a threshold amount of time (e.g., connects to the network at least 25 times per month, thereby indicating they live at the location). In some embodiments, the applications can correspond to downloaded, installed and/or web-based applications that execute on such devices and leverage the network at the location to perform application-based processing and/or network resource management implementation. Any type of application that can execute on a UE can be identified in Step 302 (e.g., Netflix®, YouTube®, Instagram®, Chrome®, Zoom®, and the like). For example, an application can be any type of augmented reality or virtual reality (AR/VR) application, and/or an associated AR/VR device executing such application (e.g., Apple Vision Pro headset, for example).

According to some embodiments, a location can correspond to, but is not limited to, a home, office, building, multi-dwelling unit (e.g., apartment complexes, for example) and/or any other type of physical location that can be configured to host and/or provide network connectivity to devices in/around the geographic area. Accordingly, in some embodiments, the network, as discussed above, can be any type of communication network (e.g., a location-based or associated network such as Wi-Fi 7 network, for example) that can enable devices to automatically connect upon being within range of the location and/or access point devices providing the network at/around the location.

Accordingly, in some embodiments, Step 302 can further involve, upon identification of the set of devices, an identification of the applications that are executing on the network from each device. According to some embodiments, identification of an application may be based on a criteria, such that, but not limited to, a certain amount of network traffic may be required to be associated with the application per a threshold time period for the application to be specifically identified. For example, if a user only uses an application once every month, and the application is simply to check stock prices, this minimal data usage may not be adequate to consider as part of the “regular” operations on the network. However, if a user, via their smart TV, streams movies at least 5 days a week, this would be considered a substantial amount of activity, therefore the applications executing on the TV to enable the streaming (e.g., Netflix®, Hulu®, for example) can be identified.

In some embodiments, Step 302 can further involve the identification of information, which can include, but is not limited to, a type of application, identity of application, version of application, subscription level associated with application, account(s) associated with application, device hosting the application, frequency of usage of application, MAC address or IP address of the device, the like, or some combination thereof.

In Step 304, engine 200 can operate to trigger the collection of network data (or activity data, used interchangeably) for each device and/or application for a predetermined period of time(s). For example, the collection can be in accordance with intervals (e.g., 8 hour spans of 24 hours so as to establish a usage schedule according to times of the day, for example), and/or can be based on detection of connectivity and usage over the network.

According to some embodiments, such network/activity data can be collected continuously and/or according to a predetermined period of time or interval. In some embodiments, the data may be collected based on detected events. In some embodiments, type and/or quantity of data may be directly tied to the type of application/device. For example, an application may only generate data for collection upon it being opened on a device and/or engaging in or causing network traffic. In another non-limiting example, a device may generate data for collection upon its initiation and connection to the network (e.g., upon a user getting home from work, their smart phone automatically connects to the Wi-Fi network upon the network becoming within range of the smart phone coming into physical range).

According to some embodiments, the collected data can include information related to, but not limited to, network usage (e.g., downloads, uploads, network resources accessed (e.g., web pages) and the like, which can be specific to a location, UE (user device, access point, for example), application and/or user, or some combination thereof), types of applications, types of devices, user identity, and the like, or some combination thereof.

In some embodiments, the collected data in Step 304 can be stored in database 108 in association with an identifier (ID) of a user, application, device, location and/or an associated account of any of the preceding user, application, device and/or location.

In Step 306, engine 200 can analyze the collected network/activity data. According to some embodiments, engine 200 can implement any type of known or to be known computational analysis technique, algorithm, mechanism or technology to analyze the collected data from Step 304.

In some embodiments, engine 200 may include a specific trained artificial intelligence/machine learning model (AI/ML), a particular machine learning model architecture, a particular machine learning model type (e.g., convolutional neural network (CNN), recurrent neural network (RNN), autoencoder, support vector machine (SVM), and the like), or any other suitable definition of a machine learning model or any suitable combination thereof.

In some embodiments, engine 200 may be configured to utilize one or more AI/ML techniques chosen from, but not limited to, computer vision, feature vector analysis, decision trees, boosting, support-vector machines, neural networks, nearest neighbor algorithms, Naive Bayes, bagging, random forests, logistic regression, and the like. By way of a non-limiting example, engine 200 can implement an XGBoost algorithm for regression and/or classification to analyze the collected data, as discussed herein.

According to some embodiments, the AI/ML computational analysis algorithms implemented can be applied and/or executed in a time-based manner, in that collected data for specific time periods can be allocated to such time periods so as to determine patterns of activity (or non-activity) according to a criteria. For example, engine 200 can execute a Bayesian determination for a 24 hour span every 8 hours, so as to segment the day according to applicable patterns, which can be leveraged to determine, derive, extract or otherwise activities/non-activities on the network according to devices/application in/around a location on the location's network.

In some embodiments and, optionally, in combination of any embodiment described above or below, a neural network technique may be one of, without limitation, feedforward neural network, radial basis function network, recurrent neural network, convolutional network (e.g., U-net) or other suitable network. In some embodiments and, optionally, in combination of any embodiment described above or below, an implementation of Neural Network may be executed as follows:
a. define Neural Network architecture/model,
b. transfer the input data to the neural network model,
c. train the model incrementally,
d. determine the accuracy for a specific number of timesteps,
c. apply the trained model to process the newly-received input data,
f. optionally and in parallel, continue to train the trained model with a predetermined periodicity.
   61. In some embodiments and, optionally, in combination of any embodiment described above or below, the trained neural network model may specify a neural network by at least a neural network topology, a series of activation functions, and connection weights. For example, the topology of a neural network may include a configuration of nodes of the neural network and connections between such nodes. In some embodiments and, optionally, in combination of any embodiment described above or below, the trained neural network model may also be specified to include other parameters, including but not limited to, bias values/functions and/or aggregation functions. For example, an activation function of a node may be a step function, sine function, continuous or piecewise linear function, sigmoid function, hyperbolic tangent function, or other type of mathematical function that represents a threshold at which the node is activated. In some embodiments and, optionally, in combination of any embodiment described above or below, the aggregation function may be a mathematical function that combines (e.g., sum, product, and the like) input signals to the node. In some embodiments and, optionally, in combination of any embodiment described above or below, an output of the aggregation function may be used as input to the activation function. In some embodiments and, optionally, in combination of any embodiment described above or below, the bias may be a constant value or function that may be used by the aggregation function and/or the activation function to make the node more or less likely to be activated.

In Step 308, based on the analysis from Step 306, engine 200 can determine a set of patterns for applications (or devices) operating on the network at the location. In some embodiments, the patterns can be specific to a user or users, to an application or application, to a device or devices, and/or some combination thereof. For example, the patterns can indicate that user A typically streams movies on his phone each weeknight from 8 pm to 10 pm in her bedroom; and user B video chats with her friends from 5 pm to 6 pm on the weekend days. In another non-limiting example, a pattern can indicate that the smart speaker in the kitchen typically streams a podcast each weekday morning that is not a holiday. According to some embodiments, the determined patterns are based on the computational AI/ML analysis performed via engine 200, as discussed above.

Accordingly, in some embodiments, the set of patterns can correspond to, but are not limited to, types of events, types of detected activity, a time of day, a date, type of user, type of application, type of device, duration, amount of activity, quantity of activities, sublocations within the location (e.g., rooms in the house, for example), and the like, or some combination thereof.

In Step 310, engine 200 can store the determined set of patterns in database 108, in a similar manner as discussed above. According to some embodiments, Step 310 can involve creating a data structure associated with each determined pattern, whereby each data structure can be stored in a proper storage location associated with an identifier of the user, application, device and/or location, as discussed above.

In some embodiments, a pattern can comprise a set of events, which can correspond to an activity and/or non-activity (e.g., downloading music content, sending work emails, and the like, for example). In some embodiments, the pattern's data structure can be configured with header (or metadata) that identifies a user, device, application or the location, and/or a time period/interval of analysis (as discussed above); and the remaining portion of the structure providing the data of the activity/non-activity. In some embodiments, the data structure for a pattern can be relational, in that the events of a pattern can be sequentially ordered, and/or weighted so that the order corresponds to events with more or less activity.

In some embodiments, the structure of the data structure for a pattern can enable a more computationally efficient (e.g., faster) search of the pattern to determine if later detected events correspond to the events of the pattern, as discussed below in relation to Process 400 of FIG. 4. In some embodiments, the data structures of patterns can be, but are not limited to, files, arrays, lists, binary, heaps, hashes, tables, trees, and the like, and/or any other type of known or to be known tangible, storable digital asset, item and/or object.

According to some embodiments, the collected data can be identified and analyzed in a raw format, whereby upon a determination of the pattern, the data can be compiled into refined data (e.g., a format capable of being stored in and read from database 108). Thus, in some embodiments, Step 310 can involve the creation and/or modification (e.g., transformation) of the collected data into a storable format.

In some embodiments, as discussed below, each pattern (and corresponding data structure) can be modified based on further detected behavior, as discussed below in relation to Process 400 of FIG. 4.

Turning to FIG. 4, Process 400 provides non-limiting example embodiments for the deployment and/or implementation of the disclosed network management framework for a network at a location.

According to some embodiments, as discussed herein, the disclosed framework, via engine 200, provides a usage-based adaptive network (e.g., WiFi 7, for example) that can prioritize application operations of devices connected to the network to ensure that high-priority operations can be performed without degradation of the network from non-preferred or non-prioritized operations/applications. As discussed herein, the disclosed framework can effectuate activation of MLO functionality for the network so as to be adaptively configured and/or modified to meet the required needs of such behaviors.

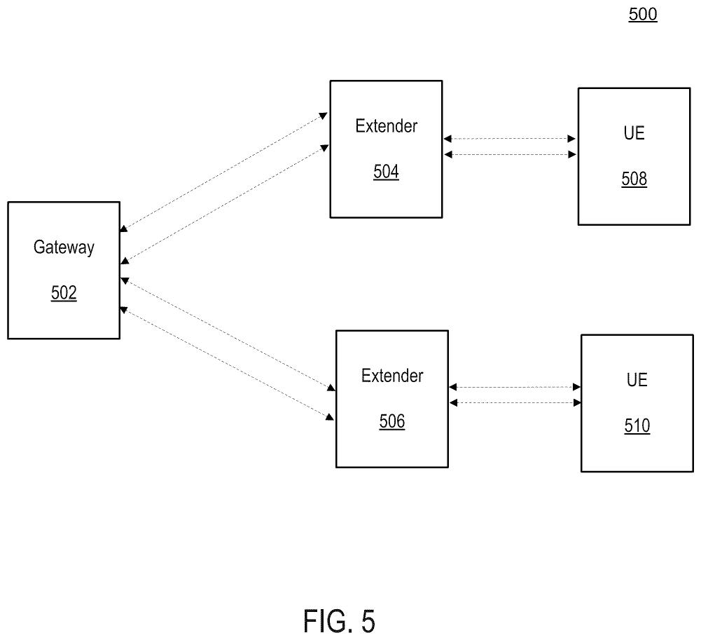

By way of a non-limiting example, with reference to FIG. 5, depicted is location 500, for which a mesh network is provided. As depicted in the illustrative embodiments, gateway 502 can provide network connectivity to UE 508 and UE 510 via extender 504 and extender 506, respectively.

As discussed herein, the disclosed network management framework (e.g., via execution of engine 200, as discussed with reference to Process 400 of FIG. 4, infra) can leverage information related to the detection of application instances on a network and determinations of such applications' priority of operations on the network (as discussed above in relation to Process 300 of FIG. 3, supra), and dynamically activate MLO links across certain branches of the topology of a location's network (e.g., the locations' operational mesh network, as discussed below).

As discussed herein, MLO in WiFi networks refers to the ability of devices to simultaneously establish multiple connections to APs or routers. MLO can enable a device to use multiple WiFi radios and/or interfaces to establish concurrent connections with multiple APs or routers, effectively increasing the overall throughput and improving network performance. As such, with multi-link operation, a device can distribute its network traffic across multiple connections, thereby utilizing the available bandwidth more efficiently. This is especially useful in scenarios where there are multiple APs or routers within range, enabling the device to aggregate the capacity of these connections to achieve higher data rates.

According to some embodiments, as discussed herein, MLO can be implemented by, but not limited to, multi-channel operation, multi-radio operation, and the like, or some combination thereof.

In some embodiments, with regard to multi-channel operation, a device can connect to multiple APs or routers operating on different WiFi channels simultaneously. Each connection can be established on a separate channel, thereby allowing the device to transmit and receive data concurrently, resulting in increased throughput.

In some embodiments, with regard to multi-radio operation, since some devices are equipped with multiple WiFi radios or interfaces, each radio can connect to a different AP or router, thereby enabling parallel transmissions and receptions across multiple connections. This functionality can provide for improved bandwidth aggregation and improved performance.

As such, MLO within a WiFi network can provide benefits including, but not limited to, improved network capacity, reduced congestion, and better utilization of available resources, inter alia. MLO is particularly beneficial in high-density environments or situations where there are multiple APs serving a single location. Thus, MLO is a valuable feature that enhances the performance and efficiency of WiFi networks, allowing devices to take advantage of multiple connections to achieve higher speeds and improved user experiences.

Thus, with reference to FIG. 5, which will be discussed with reference to the steps of Process 400, the channels, antennas or radios utilized by gateway 502, extenders 504/506 and/or UEs 508/510 can evidence the implemented of MLO, whereby MLO links can be enacted and/or rendered dormant based on the usage of each UE 508 and/or 510.

As depicted in FIG. 5, location 500's mesh network, in accordance with the disclosed embodiments, implements MLO links across all branches of the mesh network. Thus, as depicted between gateway 502 and extender 504 and 506, and between extender 504 and 506 to UE 508 and 510, respectively, the dual dashed lines represent MLO links between each node in the mesh network of location 500. The dashed lines represent different bands (or channels), which as discussed herein, can be dormant or activated.

For example, one of the dashed lines between gateway 502 and extender 504 can correspond to channel 37 in the 6 GHz band, and the other line between that connection can correspond to channel 157 in the 5 GHz band. Accordingly, the connections between the gateway 502 and extenders 504/506 can be referred to as the “back haul” links, and the connections between extenders 504/506 and UE 508/510 can be referred to as the “front haul” links.

As discussed herein, contrary to conventional mechanisms, the disclosed framework can operate to activate diverse links between the front haul and back haul links, which can enable network diversity, which can increase the operational connectivity of the WiFi 7 mesh network. For example, diverse links (e.g., frequency bands/channels, for example) can be activated and/or timely implemented between the back haul and/or front haul of a network (e.g., between different back haul links, between different front haul links, and the like, or some combination thereof), such that there is no minimal capacity made available for the network at the location. Thus, when active MLO links are not required (e.g., determined to not be needed to support the required network consumption of an application executing on a device), the disclosed framework can render front haul and/or back haul links dormant (e.g., one of the front haul links and/or one of the back haul links being rendered dormant, such that at least one link is active to ensure the connectivity is maintained); however, when an application (or device) is determined to require additional network capacity, for example, then dormant links can be activated, which can be specific to that device's operational needs and/or the network as a whole's overall network drain or resource usage.

By way of a non-limiting example, embodiments can exist where each of the 5 GHZ and 6 GHz radios across all the APs in the topology (e.g., gateway 502 and extenders 504 and 506) use the same channel in the respective bands. For example, each connection between the nodes at location can have channel 37 in the 6 GHz band and channel 157 in the 5 GHz band active. This, however, may limit channel diversity; however, there may be embodiments where such configuration/activation is required given the application-type and/or quantity usage by each UE 508/510.

By way of another non-limiting example, embodiments can exist where only a sub-branch of the mesh network topology has active MLO links. For example, the network connections between gateway 502, extender 506 and UE 510 can have active, two-channel MLO links, while the connection between gateway 502, extender 504 and UE 508 can have dormant MLO links (e.g., operating only on a single channel). In another example, gateway 502 and extender 504 can have a standard WiFi connection (e.g., single channel), whereas gateway 504 and UE 508 can have active MLO links.

Accordingly, in some embodiments, by enabling MLO dynamically only in a certain branch of the network topology of location 500, the disclosed framework can still retain the channel diversity in the rest of the network. For example, extender 504 uses Channel 44 in the front haul while extender 506 uses channel 157 in the front haul.

In some embodiments, according to the above non-limiting example, the disclosed framework can operate to dynamically activate the MLO link on the branch gateway 502—extender 504 whenever there is a need for higher performance and/or latency requirement for applications running on UE 508. Once such application halts its performance, the framework can then operate to render such 5 GHZ MLO link dormant and use the 5 GHZ radio on one of the Access Points (e.g., gateway 502, for example)) to operate in a different 5 GHZ channel. Thus, channel diversity can be established and maintained.

Accordingly, it should be understood that while the example in FIG. 5 related to the network of location 500 includes particular nodes and MLO link indicators (e.g., dashed lines), it should not be construed as limiting, as additional or fewer gateways, extenders, UEs and/or other types of APs can be included, as well as MLO links (not shown) being received by the gateway 502, without departing from the scope of the instant disclosure. Moreover, according to some embodiments, it should be understood that while the discussion herein focuses on a type of network topology (e.g., a star network topology), it should not be construed as limiting, as any type of mesh network topology, inclusive of full and partial mesh topologies can be utilized without departing from the scope of the instant disclosure. For example, the disclosed framework can operate to for topologies including, but not limited to, star, linear, ring, tree, bus, and the like, whether known or to be known.

Turning back to FIG. 4, according to some embodiments, Step 402 can be performed by identification module 202 of network management engine 200; Step 404 can be performed by monitoring module 206; Steps 406-408 can be performed by determination module 204; and Steps 410-412 can be performed by control module 208.

According to some embodiments, Process 400 begins with Step 402 where engine 200 can identify a set of applications corresponding to a current time or time period. For example, Step 402 can involve the identification of an application that is being executed by a user's smart phone that is connected to the network at the location (and is conducting network traffic with data levels being at least a threshold amount).

Accordingly, in some embodiments, Step 402 can involve identification of a set of patterns for such applications. In some embodiments, as discussed above, the set of patterns can correspond to a pattern(s) of activity stored in Step 310, discussed supra. In some embodiments, the detection of the pattern(s) can be based on, but not limited to, a time, date, activity at the location, type and/or quantity of network traffic/data, number of connected devices, settings of an access point device, settings of the service provider, user input, and the like, or some combination thereof.

For example, Step 402 can be based on a time being detected, whereby a set of patterns determined for a set of users at the location can be retrieved from storage. For example, at 6 pm on a Monday, engine 200 can retrieve the patterns for the residents of a home so that the associated and proper mode of the location's network can be properly provisioned, as discussed herein. In another example, Step 402 can be based on an application opening on a UE, whereby upon such application session being initiated, engine 200 can retrieve corresponding application pattern data from storage.

In Step 404, engine 200 can perform operations of monitoring the network. In some embodiments, such monitoring can be (e.g., either additionally or alternatively) based on a set of patterns identified in Step 402. In some embodiments, such monitoring can be effectuated via the engine 200 operating on UE 102 and/or any other device of system 100, as discussed above in relation to FIG. 1. For example, engine 200 can collect activity data for an application on a device of a user at the location from their smartphone (e.g., UE 102).

In some embodiments, engine 200 can monitor the location continuously, according to a predetermined time interval and/or according to a type of criteria (e.g., event, action, location, and the like). In some embodiments, the monitoring can involve push and/or fetch protocols to collect activity data from each connected device.

In Step 406, based on the monitoring and collection of activity data in Step 404, engine 200 can analyze the collected activity data (and, in some embodiments, the pattern information via any type of AI/ML model), whereby such analysis can be performed in a similar manner as discussed above at least in relation to the AI/ML modeling of Step 306 of Process 300. Such analysis, as discussed herein, can enable engine 200's determination and management of MLO links between network nodes at a location; in other words, engine 200 can determine the operational configurations of the network respective to particular applications, devices and/or users, which can be utilized so as to enable modifications to the network parameters, firmware, software and/or hardware at the location, which can cause scaling of the network's capabilities and/or implementation. Moreover, other factors or network features can be utilized to enable modifications, which can include, but are not limited to, type of activity, time of day, date, and the like.

Thus, in Step 408, according to some embodiments, engine 200 can compile the collected data from Step 404, and the information from the identified set of patterns from Step 402, and determine the network diversity parameters for each device (also referred to network parameters, used interchangeably). According to some embodiments, the network diversity parameters can enable state and/or mode transitions, radio activations, channel selection/switch and/or traffic/bandwidth allocations on/within the network. In some embodiments, the network diversity parameters can correspond to, but are not limited to, bandwidth, latency, packet size, signal strength, downloading, uploading, transmission power and transmission frequency, and the like, or some combination thereof.

Thus, according to some embodiments, the determined network diversity parameters can correspond to, but not be limited to, which types of network features or characteristics are required for the applications, devices and/or their associated types. For example, applications with large demands on download speeds can have network diversity parameters indicating a need for MLO activation (e.g., identify which channels are preferred, which bands, which radios, and/or indicate a desire to activate specific channels, bands and/or radios, and the like), whereas applications that have small digital footprints on network (e.g., an SMS application, for example, WhatsApp®) may have network diversity parameters that defer to other types of applications given their ability to operate in low bandwidth, high latency environments.

Continuing with Process 400, in Step 410, engine 200 can configure the network components at the location based on the determined network diversity parameters (e.g., based on the demand of particular applications and/or devices connected to the network at the location). According to some embodiments, such configurations can correspond to management, control and/or changes to which channels, interfaces and/or antennas are available (e.g., MLO components of the network), as well as how frequent such channels, interfaces and/or antennas communicate and/or process network based information. Indeed, the operational configuration in Step 410 can be applied to a network such that a specific application can cause activation of and be directed to specific channels on the network so that their network traffic is guaranteed a certain amount (e.g., a minimum and/or range) of available bandwidth and/or threshold amount of network speeds.

For example, based on the discussion above with respect to FIG. 5, UE 510 can be operating a video conferencing application (e.g., Microsoft Teams®, for example). Engine 200, for example, according to some embodiments, can determine such application is operating based on analysis of a pattern for the device/user and/or upon detection that the application instance is opened on the user's laptop. Accordingly, the front haul connection between UE 510 can be subject to MLO link activation. However, as discussed above, the MLO links between the user's smart phone (e.g., UE 508) can remain dormant.

Turning back to Process 400, according to some embodiments, based on the network, hardware and/or software configurations of Step 410, engine 200 can facilitate network activity for each device. In some embodiments, engine 200 can perform and/or effectuate Step 412 where the network can be provided (e.g., provisioned, enacted, initiated, modified, updated and/or made accessible, for example) according to the modified capabilities (e.g., specifically activated MLO links, as discussed herein).

In some embodiments, as depicted in FIG. 4, Process 400 can recursively proceed from Step 412 to Step 404, where the network traffic and/or characteristics can be monitored so as to ensure the proper network configuration is currently being activated and implemented for the location and/or the applications operating therein. This, for example, can enable MLO links to be “turned off” (or rendered dormant) and/or activated upon further monitoring of the network's usage via the connected applications/devices.

According to some embodiments, a network can have a dedicated engine 200 model so that the network management protocols applied to the network can be specific to the events and patterns learned and detected on that network. In some embodiments, the model can be specific for an application, set of applications, a device, set of devices and/or user or set of users (e.g., users that live at a certain location (e.g., a house), and/or are within a proximity to each other (e.g., work on the same floor of an office building, for example)).

FIG. 8 is a schematic diagram illustrating a client device showing an example embodiment of a client device that may be used within the present disclosure. Client device 800 may include many more or less components than those shown in FIG. 8. However, the components shown are sufficient to disclose an illustrative embodiment for implementing the present disclosure. Client device 800 may represent, for example, UE 102 discussed above at least in relation to FIG. 1.

As shown in the figure, in some embodiments, Client device 800 includes a processing unit (CPU) 822 in communication with a mass memory 830 via a bus 824. Client device 800 also includes a power supply 826, one or more network interfaces 850, an audio interface 852, a display 854, a keypad 856, an illuminator 858, an input/output interface 860, a haptic interface 862, an optional global positioning systems (GPS) receiver 864 and a camera(s) or other optical, thermal or electromagnetic sensors 866. Device 800 can include one camera/sensor 866, or a plurality of cameras/sensors 866, as understood by those of skill in the art. Power supply 826 provides power to Client device 800.

Client device 800 may optionally communicate with a base station (not shown), or directly with another computing device. In some embodiments, network interface 850 is sometimes known as a transceiver, transceiving device, or network interface card (NIC).

Audio interface 852 is arranged to produce and receive audio signals such as the sound of a human voice in some embodiments. Display 854 may be a liquid crystal display (LCD), gas plasma, light emitting diode (LED), or any other type of display used with a computing device. Display 854 may also include a touch sensitive screen arranged to receive input from an object such as a stylus or a digit from a human hand.

Keypad 856 may include any input device arranged to receive input from a user. Illuminator 858 may provide a status indication and/or provide light.

Client device 800 also includes input/output interface 860 for communicating with external. Input/output interface 860 can utilize one or more communication technologies, such as USB, infrared, Bluetooth™, or the like in some embodiments. Haptic interface 862 is arranged to provide tactile feedback to a user of the client device.

Optional GPS transceiver 864 can determine the physical coordinates of Client device 800 on the surface of the Earth, which typically outputs a location as latitude and longitude values. GPS transceiver 864 can also employ other geo-positioning mechanisms, including, but not limited to, triangulation, assisted GPS (AGPS), E-OTD, CI, SAI, ETA, BSS or the like, to further determine the physical location of client device 800 on the surface of the Earth. In one embodiment, however, Client device may through other components, provide other information that may be employed to determine a physical location of the device, including for example, a MAC address, Internet Protocol (IP) address, or the like.

Mass memory 830 includes a RAM 832, a ROM 834, and other storage means. Mass memory 830 illustrates another example of computer storage media for storage of information such as computer readable instructions, data structures, program modules or other data. Mass memory 830 stores a basic input/output system (“BIOS”) 840 for controlling low-level operation of Client device 800. The mass memory also stores an operating system 841 for controlling the operation of Client device 800.

Memory 830 further includes one or more data stores, which can be utilized by Client device 800 to store, among other things, applications 842 and/or other information or data. For example, data stores may be employed to store information that describes various capabilities of Client device 800. The information may then be provided to another device based on any of a variety of events, including being sent as part of a header (e.g., index file of the HLS stream) during a communication, sent upon request, or the like. At least a portion of the capability information may also be stored on a disk drive or other storage medium (not shown) within Client device 800.

Applications 842 may include computer executable instructions which, when executed by Client device 800, transmit, receive, and/or otherwise process audio, video, images, and enable telecommunication with a server and/or another user of another client device. Applications 842 may further include a client that is configured to send, to receive, and/or to otherwise process gaming, goods/services and/or other forms of data, messages and content hosted and provided by the platform associated with engine 200 and its affiliates.

As used herein, the terms “computer engine” and “engine” identify at least one software component and/or a combination of at least one software component and at least one hardware component which are designed/programmed/configured to manage/control other software and/or hardware components (such as the libraries, software development kits (SDKs), objects, and the like).

Examples of hardware elements may include processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), logic gates, registers, semiconductor device, chips, microchips, chip sets, and so forth. In some embodiments, the one or more processors may be implemented as a Complex Instruction Set Computer (CISC) or Reduced Instruction Set Computer (RISC) processors; x86 instruction set compatible processors, multi-core, or any other microprocessor or central processing unit (CPU). In various implementations, the one or more processors may be dual-core processor(s), dual-core mobile processor(s), and so forth.

Computer-related systems, computer systems, and systems, as used herein, include any combination of hardware and software. Examples of software may include software components, programs, applications, operating system software, middleware, firmware, software modules, routines, subroutines, functions, methods, procedures, software interfaces, API, instruction sets, computer code, computer code segments, words, values, symbols, or any combination thereof. Determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints.

For the purposes of this disclosure a module is a software, hardware, or firmware (or combinations thereof) system, process or functionality, or component thereof, that performs or facilitates the processes, features, and/or functions described herein (with or without human interaction or augmentation). A module can include sub-modules. Software components of a module may be stored on a computer readable medium for execution by a processor. Modules may be integral to one or more servers, or be loaded and executed by one or more servers. One or more modules may be grouped into an engine or an application.

One or more aspects of at least one embodiment may be implemented by representative instructions stored on a machine-readable medium which represents various logic within the processor, which when read by a machine causes the machine to fabricate logic to perform the techniques described herein. Such representations, known as “IP cores,” may be stored on a tangible, machine readable medium and supplied to various customers or manufacturing facilities to load into the fabrication machines that make the logic or processor. Of note, various embodiments described herein may, of course, be implemented using any appropriate hardware and/or computing software languages (e.g., C++, Objective-C, Swift, Java, JavaScript, Python, Perl, QT, and the like).

For example, exemplary software specifically programmed in accordance with one or more principles of the present disclosure may be downloadable from a network, for example, a website, as a stand-alone product or as an add-in package for installation in an existing software application. For example, exemplary software specifically programmed in accordance with one or more principles of the present disclosure may also be available as a client-server software application, or as a web-enabled software application. For example, exemplary software specifically programmed in accordance with one or more principles of the present disclosure may also be embodied as a software package installed on a hardware device.

For the purposes of this disclosure the term “user”, “subscriber” “consumer” or “customer” should be understood to refer to a user of an application or applications as described herein and/or a consumer of data supplied by a data provider. By way of example, and not limitation, the term “user” or “subscriber” can refer to a person who receives data provided by the data or service provider over the Internet in a browser session, or can refer to an automated software application which receives the data and stores or processes the data. Those skilled in the art will recognize that the methods and systems of the present disclosure may be implemented in many manners and as such are not to be limited by the foregoing exemplary embodiments and examples. In other words, functional elements being performed by single or multiple components, in various combinations of hardware and software or firmware, and individual functions, may be distributed among software applications at either the client level or server level or both. In this regard, any number of the features of the different embodiments described herein may be combined into single or multiple embodiments, and alternate embodiments having fewer than, or more than, all of the features described herein are possible.

Functionality may also be, in whole or in part, distributed among multiple components, in manners now known or to become known. Thus, myriad software/hardware/firmware combinations are possible in achieving the functions, features, interfaces and preferences described herein. Moreover, the scope of the present disclosure covers conventionally known manners for carrying out the described features and functions and interfaces, as well as those variations and modifications that may be made to the hardware or software or firmware components described herein as would be understood by those skilled in the art now and hereafter.

Furthermore, the embodiments of methods presented and described as flowcharts in this disclosure are provided by way of example in order to provide a more complete understanding of the technology. The disclosed methods are not limited to the operations and logical flow presented herein. Alternative embodiments are contemplated in which the order of the various operations is altered and in which sub-operations described as being part of a larger operation are performed independently.

While various embodiments have been described for purposes of this disclosure, such embodiments should not be deemed to limit the teaching of this disclosure to those embodiments. Various changes and modifications may be made to the elements and operations described above to obtain a result that remains within the scope of the systems and processes described in this disclosure.

What is claimed is:

1. A method comprising:
detecting, by a device, an application executing in association with a network at a location;
analyzing, by the device, network data corresponding to the application execution;
determining, by the device, based on the analysis, a set of network parameters, the set of network parameters indicating requirements related to connectivity and capacity capabilities of the network;
configuring, by the device, multi-link operation (MLO) components of the network based on the determined set of network parameters; and
facilitating, by the device, network activity for the application via the configured MLO components.

2. The method of claim 1, wherein the MLO components correspond to at least one of a channel, band, radio and interface associated with the network.

3. The method of claim 1, further comprising:
determining, based on the set of network parameters, to activate the MLO components associated with a connection of the device, wherein the configuration of the MLO components is based on the activation determination.

4. The method of claim 1, wherein the activated MLO component is in a dormant state until the activation.

5. The method of claim 1, wherein the set of network parameters correspond to at least one of bandwidth, latency, packet size, signal strength, downloading, uploading, transmission power and transmission frequency.

6. The method of claim 1, further comprising:
collecting activity data from a plurality of applications operating on the network;
analyzing the activity data;
determining a plurality of patterns of behavior for the network; and
storing the determined plurality of patterns of behavior.

7. The method of claim 6, further comprising:
analyzing, in association with the application, a set of patterns, the set of patterns being identified from the stored plurality of patterns of behavior;
determining, based on the analysis of the set of patterns, a time corresponding to the application execution, wherein the time is indicated in at least one pattern in the set of patterns, wherein the detection of the application is based on the determined time.

8. The method of claim 1, wherein the network is a location-specific network, wherein the network is a WiFi mesh network, wherein the WiFi mesh network comprises front haul and back haul components between nodes of the network, wherein the front haul and back haul components comprise the MLO components.

9. The method of claim 1, wherein the device is a user device.

10. The method of claim 1, wherein the device is an access point for a location.

11. A device comprising:
a processor configured to:
detect an application executing in association with a network at a location;
analyze network data corresponding to the application execution;
determine, based on the analysis, a set of network parameters, the set of network parameters indicating requirements related to connectivity and capacity capabilities of the network;
configure multi-link operation (MLO) components of the network based on the determined set of network parameters; and
facilitate network activity for the application via the configured MLO components.

12. The device of claim 11, wherein the MLO components correspond to at least one of a channel, band, radio and interface associated with the network.

13. The device of claim 11, wherein the processor is further configured to:
determine, based on the set of network parameters, to activate the MLO components associated with a connection of the device, wherein the configuration of the MLO components is based on the activation determination, wherein the activated MLO component is in a dormant state until the activation.

14. The device of claim 11, wherein the processor is further configured to:
analyze, in association with the application, a set of patterns, the set of patterns being identified from a stored plurality of patterns of behavior;
determine, based on the analysis of the set of patterns, a time corresponding to the application execution, wherein the time is indicated in at least one pattern in the set of patterns, wherein the detection of the application is based on the determined time.

15. The device of claim 11, wherein the network is a location-specific network, wherein the network is a WiFi mesh network, wherein the WiFi mesh network comprises front haul and back haul components between nodes of the network, wherein the front haul and back haul components comprise the MLO components.

16. A non-transitory computer-readable storage medium tangibly encoded with computer-executable instructions that when executed by a device, perform a method comprising:
detecting, by the device, an application executing in association with a network at a location;
analyzing, by the device, network data corresponding to the application execution;
determining, by the device, based on the analysis, a set of network parameters, the set of network parameters indicating requirements related to connectivity and capacity capabilities of the network;
configuring, by the device, multi-link operation (MLO) components of the network based on the determined set of network parameters; and
facilitating, by the device, network activity for the application via the configured MLO components.

17. The non-transitory computer-readable storage medium of claim 16, wherein the MLO components correspond to at least one of a channel, band, radio and interface associated with the network.

18. The non-transitory computer-readable storage medium of claim 16, further comprising:
determining, based on the set of network parameters, to activate the MLO components associated with a connection of the device, wherein the configuration of the MLO components is based on the activation determination, wherein the activated MLO component is in a dormant state until the activation.

19. The non-transitory computer-readable storage medium of claim 16, further comprising:
analyzing, in association with the application, a set of patterns, the set of patterns being identified from a stored plurality of patterns of behavior;
determining, based on the analysis of the set of patterns, a time corresponding to the application execution, wherein the time is indicated in at least one pattern in the set of patterns, wherein the detection of the application is based on the determined time.

20. The non-transitory computer-readable storage medium of claim 16, wherein the network is a location-specific network, wherein the network is a WiFi mesh network, wherein the WiFi mesh network comprises front haul and back haul components between nodes of the network, wherein the front haul and back haul components comprise the MLO components.
